(19) United States
(12) Patent Application Publication
(10) Pub. No.: US 2008/0303786 A1
(43) Pub. Date: Dec. 11, 2008

(54) DISPLAY DEVICE

(75) Inventors: Hiroki NAKAMURA, Ageo-shi (JP); Hirotaka Hayashi, Fukaya-shi (JP); Takashi Nakamura, Saitama-shi (JP); Takayuki Imai, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 12/026,814

(22) Filed: Feb. 6, 2008

(30) Foreign Application Priority Data
Jun. 6, 2007 (JP) 2007-150620

(51) Int. Cl. G06F 3/033

(52) U.S. Cl. 345/156; 382/173

(57) ABSTRACT

An object of the present invention is to achieve an advanced input operation without complicating image processing. A display device of the present invention includes a display unit, an optical input unit, and an image processor. The display unit displays an image on a display screen. The optical input unit captures an image of an object approaching the display screen. The image processor detects that the object comes into contact with the display screen on the basis of a captured image captured by the optical input unit, and then performs image processing to obtain the position coordinates of the object. In the display device, the image processor divides the captured image into a plurality of regions, and performs the image processing on each of the divided regions.

### CROSS-REFERENCE TO RELATED APPLICATIONS

This application is based upon and claims the benefit of priority from Japanese Patent Application No. 2007-150620 filed Jun. 6, 2007; the entire contents of which are incorporated herein by reference.

### BACKGROUND OF THE INVENTION

1. Field of the Invention

The present invention relates to a display device provided with an input function such as a touch panel, and particularly relates to a display device provided with an optical input function for receiving information by use of an incident light through a display screen.

2. Description of the Related Art

A liquid crystal display device includes an array substrate and a drive circuit. The array substrate includes signal lines, scan lines, thin film transistors (TFT) and the like formed therein. The drive circuit drives the signal lines and the scan lines. A recent development of integrated circuit technology has made it possible to form thin film transistors and part of the drive circuit on the array substrate by means of a polysilicon process. Accordingly, liquid crystal display devices have been reduced in size, and become widely used as display devices in portable equipment such as a cellular phone and a laptop computer.

In addition, another type of liquid crystal display device has been proposed. In this device, photoelectric conversion elements are distributed as contact-type area sensors on an array substrate. Such a display device is described in, for example, Japanese Patent Application Laid-open Publications Nos. 2001-292276, 2001-339640, and 2004-93894.

In a generally-used display device provided with an image input function, a capacitor connected to each photoelectric conversion element is firstly charged, and then the amount of the charge is reduced in accordance with the amount of light received in the photoelectric conversion element. The display device detects the voltage between the two ends of the capacitor after a predetermined time period, and obtains a captured image by converting the voltage into a gray value. The display device can capture a finger approaching the display screen, and then determine whether or not the finger comes into contact with the display screen (hereinafter, sometimes referred to simply as a contact determination) on the basis of a change in shape of the image at the time of the contact of the finger.

When the contact determination is performed, a gravity center of a finger is calculated by using a captured image on the entire display screen. For this reason, when plural fingers (two fingers, for example) touch the screen as in the case of a touch panel using a resistive film, contact coordinates (indicating the middle position between the two fingers) that are different from the coordinates of the contact position of each finger are outputted. Although most of the currently-available touch panels can receive an input by a single finger, a touch panel allowing an input by plural fingers is demanded in response to a request for a more advanced input operation. However, it is difficult to cause a touch panel using a resistive film to recognize plural fingers.

On the other hand, another type of display device has recently been developed that can specify a contact position by image processing using a captured image. Such a display device that specifies a contact position by image processing is described in, for example, Japanese Patent Application Laid-open Publication No. 2007-58552. In such display device, each finger is specified by labeling processing, so that plural fingers can be recognized. For example, the labeling processing is useful as a method for specifying target regions in a case where plural objects exist in an image as shown in FIG. 1. In a binarized image processed through the labeling processing, a label (number) is attached to each pixel as an attribute, so that a particular region can be extracted.

However, since such a display device performs the processing on a captured image frame by frame in order to specify a contact position from the captured image, the scale of the processing becomes large. As a result, a problem arises that an IC for image processing is increased in size. Moreover, it is difficult to operate, by using many fingers, a display device with a small display size, for example, from 2 to 4 inches, such as cellular phones.

### SUMMARY OF THE INVENTION

An object of the present invention is to achieve an advanced input operation without complicating image processing in a display device provided with an input function.

A display device according to the present invention includes a display unit, an optical input unit, and an image processor. The display unit displays an image on a display screen. The optical input unit captures an image of an object approaching the display screen. The image processor detects that the object comes into contact with the display screen, and then performs an image processing operation to obtain the position coordinates of the object. Moreover, the image processor divides the captured image into a plurality of regions, and performs the image processing operation on each of the divided regions.

In the present invention, when a plurality of objects approach the display screen, it is possible to detect the position coordinates of each object in a corresponding one of the regions. Accordingly simultaneous input operations using a plurality of fingers can be achieved.

The optical input unit in the display device may be an optical sensor which detects an incident light through the display screen, and which then coverts a signal of the detected light into an electrical signal with a magnitude corresponding to the amount of the received light. Then, the image processor may further perform any one of: image processing to recognize an increase or a decrease in the value of the electrical signal at the position coordinates of the object in each of the divided regions; and image processing to recognize the distance between the position coordinates of one of a plurality of objects and the position coordinates of another one of the plurality of objects.

This configuration makes it possible to perform an input operation, for example, zooming in or out a map displayed on the screen by recognizing an increase or a decrease in distance between the position coordinates of a finger and the position coordinates of another finger. Moreover, the following input operation can be performed for example. Specifically, upon detection of that a finger approaches the display screen on the basis of a change in the values of the electrical signal, a plurality of icons may be increased in size, or sub icons included in a main icon may be displayed.

The image processor in the display device may divide the captured image into a plurality of regions in advance. Then, upon detection of the contact of the object with each of the divided regions in the display screen, the image processor may further perform image processing to change a first region where the contact of the object is detected to a second region including the position coordinates of the object, and also being smaller than the first region.

Upon detecting the contact of the object with the display screen, the image processor of the display device may further perform image processing to divide the captured image into a center region including the position coordinates of the object and a peripheral region located around the first region.

The image processor of the display device may detect a movement of the position coordinates of the object in each of the divided region. Then, the image processor may further perform image processing to dynamically change, in accordance with the movement of the position coordinates, a region where the movement of the position coordinates of the object is detected.

When an object comes into contact with each of the divided regions, the region is changed to another region including the position coordinates of the object, and also being smaller than the original region. Concurrently, a movement of the position coordinates of the object is detected, and then image processing is performed to dynamically change, in accordance with the movement of the position coordinates, a region where the movement of the position coordinates of the object is detected. This configuration makes it possible to perform, for example, operations of dragging or scrolling plural icons displayed on the screen.

### BRIEF DESCRIPTION OF THE DRAWINGS

FIG. 1 is a diagram for explaining labeling processing.

FIG. 2 is a block diagram showing the configuration of a display device according to a first embodiment.

FIG. 3 is a plan view showing the configuration of the display device shown in FIG. 1.

FIG. 4 is a cross-sectional view showing the configuration of the display device shown in FIG. 1.

FIG. 5 shows a first application example of the display device according to the first embodiment.

FIG. 6 shows a second application example of the display device according to the first embodiment.

FIG. 7 shows a third application example of the display device according to the first embodiment.

FIG. 8 shows a fourth application example of the display device according to the first embodiment.

FIG. 9 is a flowchart showing a process flow in which a processing region is dynamically changed in a display device according to a second embodiment.

FIG. 10 shows an example of processing regions initially set in the display device according to the second embodiment.

FIG. 11 shows an example of a case where the processing regions are changed in the display device according to the second embodiment.

FIG. 12 shows a first example schematically illustrating the changing of the processing regions in the display device according to the second embodiment.

FIG. 13 shows an example of a case of dragging, by using fingers, icons displayed on the display device according to the second embodiment.

FIG. 14 shows a second example schematically illustrating the changing of the processing regions in the display device according to the second embodiment.

FIGS. 15A, 15B, and 15C show examples in each of which a captured image on a QVGA panel is divided into plural processing regions.

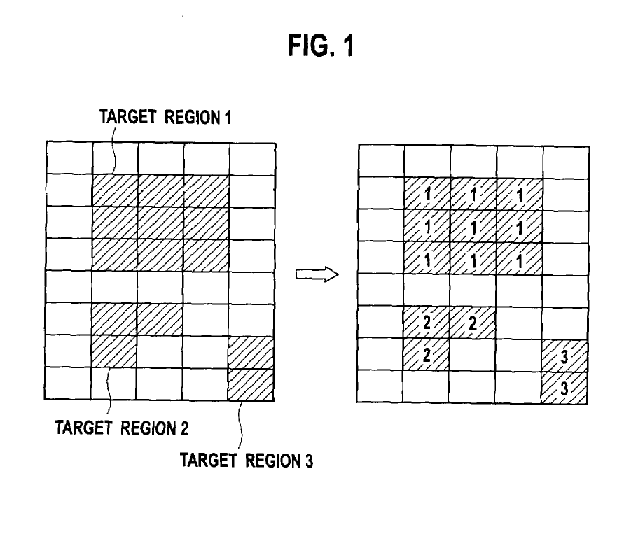

### DESCRIPTION OF THE EMBODIMENTS

### First Embodiment

Hereinafter, descriptions will be given of an embodiment of the present invention with reference to the drawings.

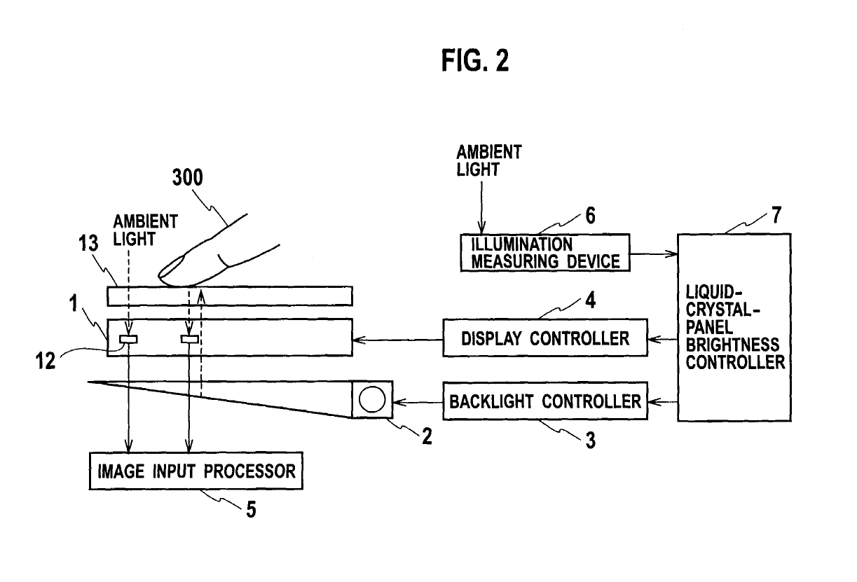

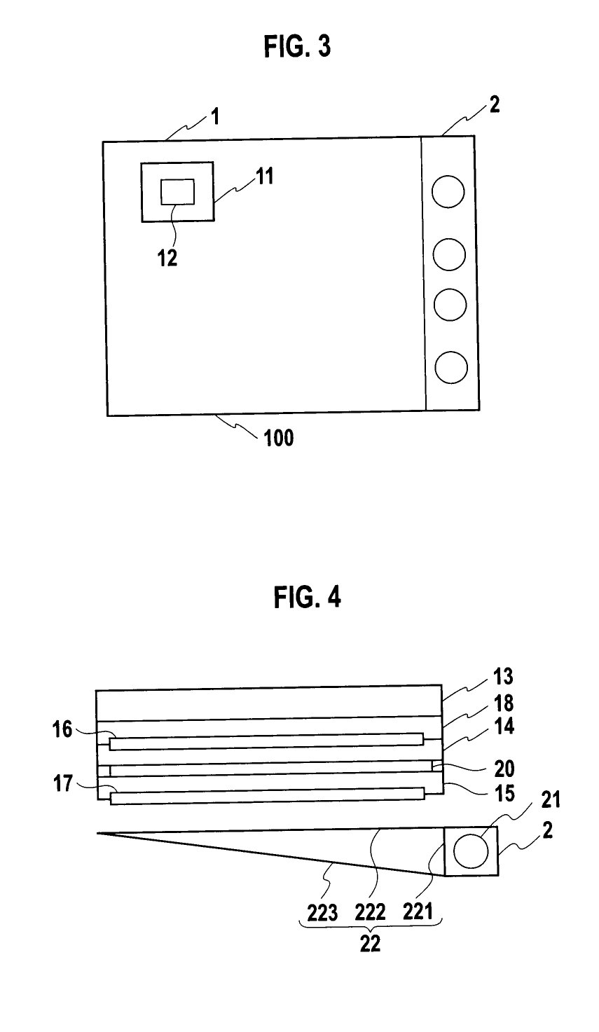

FIG. 2 is a block diagram showing the configuration of a display device according to this embodiment. The display device according to this embodiment includes a liquid crystal panel 1, a backlight 2, a backlight controller 3, a display controller 4, an image input processor 5, an illumination measuring device 6, and a liquid-crystal-panel brightness controller 7. The liquid crystal panel 1 provided with a protection plate 13 displays an image, and also detects, by using optical sensors 12, the amount of received light including: ambient light incoming a display screen; and reflected light reflected from a finger on the protection plate 13. The backlight 2 is arranged on the back surface of the liquid crystal panel 1, and emits light to the liquid crystal panel 1. In this embodiment, the backlight controller 3, the display controller 4, the image input processor 5, the illumination measuring device 6, and the liquid-crystal-panel brightness controller 7 are integrated (into an IC) outside the liquid crystal panel 1. These components 3 to 7 may alternatively be integrated on the liquid crystal panel 1 by means of the polysilicon TFT technology. Hereinafter, each component will be described in detail with reference to FIGS. 3 and 4 as well.

FIG. 3 is a plan view showing the configuration of the liquid crystal panel 1. As shown in FIG. 3, the liquid crystal panel 1 includes plural display elements 11, and the optical sensors 12 formed respectively in the display elements 11. The liquid crystal panel 1 displays an image by using the display elements 11, and detects the amount of received light by using the optical sensors 12, in a display screen region 100. The optical sensors 12 do not necessarily need to be formed in all the display elements 11. For example, one optical sensor 12 may be formed for each three display elements 11. Each optical sensor 12 outputs, to the image input processor 5, an electrical signal with a magnitude corresponding to the detected amount of received light. The image input processor 5 converts electrical signals into gray values so as to obtain a captured image.

FIG. 4 is a cross-sectional view showing the configuration of the liquid crystal panel 1. As shown in FIG. 4, the liquid crystal panel 1 includes: a counter substrate 14; an array substrate 15; a liquid crystal layer 20 sandwiched between the counter substrate 14 and the array substrate 15; and polarizing plates 16 and 17 disposed respectively on the outer side of the counter substrate 14 and the outer side of the array substrate 15. The protection plate 13 is disposed, with an adhesive 18 in between, on the polarizing plate 16 disposed on a face where an image is displayed. The adhesive 18 used here may be a member (for example, a light curable adhesive) having substantially the same refractive index as that of the protection plate 13 for the purpose of suppressing reflection of light on the interface between the protection plate 13 and the adhesive 18. This makes it possible to suppress reflection of light on the interface, on the liquid crystal layer 20 side, of the protection plate 13, and to thus reduce reflection of a displayed image in a captured image.

In addition, in the array substrate 15, plural signal lines and plural scan lines are arranged in a matrix. The display element 11 is disposed in the intersection of each single line and each scan line. A TFT, a pixel electrode, and the optical sensor 12 are formed in each of the display elements 11. A drive circuit for driving the signal lines and the scan lines is formed on the array substrate 15. Counter electrodes are formed in the counter substrate 14 to face the respective pixel electrodes formed in the array substrate 15.

The backlight 2 includes a visible light source 21 and a light-guiding plate 22. A white light-emitting diode or the like is used for the visible light source 21. The visible light source 21 is covered with a reflecting plate formed of a white resin sheet or the like having a high reflectance so that an emitted light can effectively enter the light-guiding plate 22. The light-guiding plate 22 is formed of a transparent resin having a high refractive index (polycarbonate resin, methacrylate resin, or the like). The light-guiding plate 22 includes an incident surface 221, an outgoing surface 222, and a counter surface 223 facing the outgoing surface 222 in an inclined manner. A light entering through the incident surface 221 repeats total reflection between the outgoing surface 222 and the counter surface 223 while traveling through the light-guiding plate 22, and is eventually emitted from the outgoing surface 222. Note that, a diffuse reflection layer, a reflection groove, and the like, each having particular density distribution and size, are formed in the outgoing surface 222 and the counter surface 223 so that light can be emitted uniformly.

The backlight controller 3 controls the intensity of light emitted from the visible light source 21 of the backlight 2. When the intensity of ambient light is low, the backlight controller 3 reduces the intensity of the emitted light to suppress reflection of light on the protection plate 13 so as to prevent a displayed image from being reflected in a captured image.

The display controller 4 sets the voltages of the pixel electrodes via the signal lines and the TFTs by using the drive circuit formed in the liquid crystal panel 1. The display controller 4 thus changes the electric field strength between each pixel electrode and the corresponding counter electrode in the liquid crystal layer 20 so as to control the transmittance of the liquid crystal layer 20. Setting the transmittance individually for each display element 11 makes it possible to set the transmittance distribution corresponding to the content of an image to be displayed.

The image input controller 5 receives an electrical signal with a magnitude corresponding to the amount of a received light from the optical sensor 12 disposed in each display element 11 so as to obtain a captured image of an object. From the captured image, the image input controller 5 calculates the position coordinates of the object, and also determines whether or not the object is in contact with the display screen (hereinafter, referred to simply as a contact determination). In order to obtain an optimum captured image in both of a bright place and a dark place, it is desirable that the exposure time and the pre-charge voltage of the optical sensors 12 be controlled by a captured image controller in accordance with the illumination intensity of ambient light. When the contact determination is performed, the range of the captured image to be processed is changed in accordance with an image displayed in the liquid crystal panel 1. This makes it possible to suppress the influence of the reflection of the displayed image in the captured image. Accordingly, contact coordinates can be more accurately obtained. Here, the contact coordinates refer to the position coordinates of an object in a captured image in a case where it is determined that the object has come into contact with the display screen. The specific operations for the image capturing and the contact determination will be described later.

The illumination measuring device 6 measures the intensity of ambient light. A method of detecting contact coordinates is changed in accordance with the intensity of ambient light measured by the illumination measuring device 6. This makes it possible to detect contact coordinates regardless of whether the intensity of ambient light is high or low. The intensity of ambient light may be measured by using an optical sensor for measuring illumination intensity, or by obtaining a numerical value corresponding to the intensity of ambient light from data of an image captured by the optical sensors 12 disposed in the display elements 11. Suppose the case of setting, for the optical sensors 12 disposed in the display elements 11, the optimum exposure time and pre-charge voltage by firstly receiving ambient light by the optical sensors 12, and by then using parameters depending on the intensity of the ambient light. In this case, although a measured value of the entire display screen region may be used, it is desirable to use a measured value of a range of a captured image to be processed, which range is changed in accordance with a displayed image in the aforementioned manner.

The liquid-crystal-panel brightness controller 7 controls the brightness of the liquid crystal panel 1.

Hereinafter, the operation of the image input processor 5 will be described.

The image input processor 5 receives an electrical signal with a magnitude corresponding to the amount of a received light detected by each optical sensor 12. The image input processor 5 then obtains a captured image by converting the magnitudes of the electrical signals into gray values. Each optical sensor 12 detects the intensity of an ambient light that has not been blocked by the object whose image is to be captured (hereinafter, referred to as an image-capturing object), and also detects the intensity of a light reflected on the image-capturing object after being emitted from the liquid crystal panel 1. The contact determination between the object and the display screen is performed in the following manner on the basis of a captured image. Specifically, the contact determination is made by detecting the position and movement of the image-capturing object, and also a change in gradation and shape in the captured image at the time when the image-capturing object comes into contact with the liquid crystal panel 1. At this time, the captured image is divided into any plural processing regions, and it is determined whether or not the image-capturing object comes into contact with the display screen for each of the processing regions. Then, image processing to obtain the contact coordinates of the object is performed for each processing region in parallel.

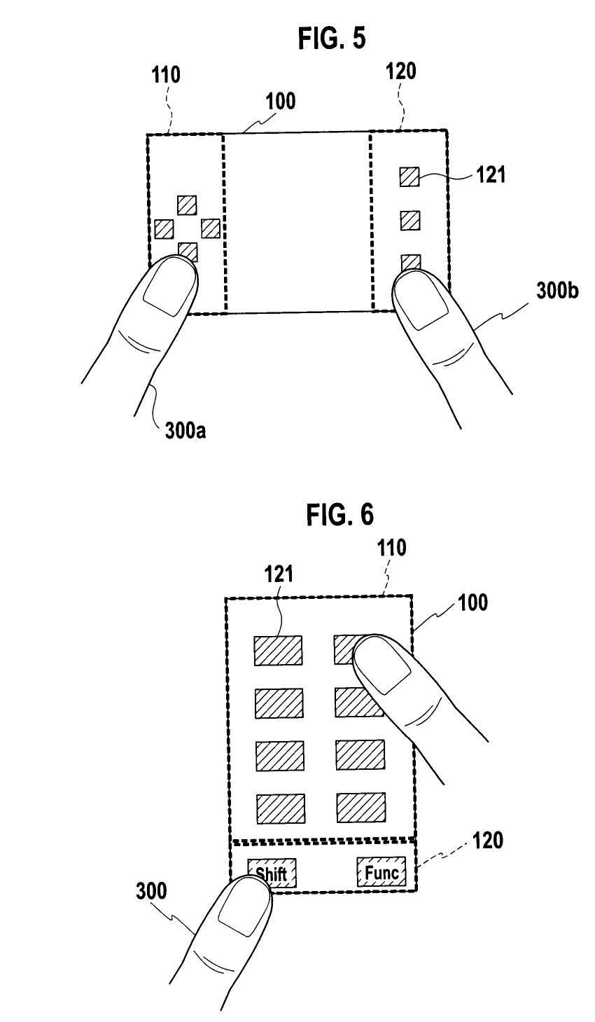

FIG. 5 to FIG. 8 each show an application example of the case of detecting the contact coordinates and the contact information in plural processing regions. FIG. 5 shows a first application example. As shown in FIG. 5, in this example, the display screen region 100 is arranged transversely. A captured image is processed by being divided into a first capture processing region 110 and a second capture processing region 120, which are each surrounded by a dashed line in the figure, and arranged respectively on the left and right ends. In the first capture processing region 110, the contact determination is performed as to whether or not a finger 300a of the left hand comes into contact with one of displayed icons 121, and concurrently the position coordinates of the finger 300a are detected. On the other hand, in the second capture processing region 120, the contact determination is performed as to whether or not a finger 300b of the right hand comes into contact with one of the displayed icons 121, and concurrently the position coordinates of the finger 300b are detected. The contact determination and the detection are processed for the regions 110 and 120 in parallel. This makes it possible to perform an input operation by touching the icons 121 as if, for example, the user is using left and right buttons of a remote controller of a video game.

In FIG. 5, the two rectangles indicating the capture processing regions 110 and 120 on the left and right sides are spaced apart from each other by the center of the display screen region 100. However, the left and right capture processing regions may be set by dividing the display screen region 100 into two halves. Even in this case, since the number of image processing regions is not increased, there is no need for increasing the memory. Moreover, since the image processing in each region is not made different from that in the case shown in FIG. 5 in which one finger is recognized in each region, the increase of logic operations is suppressed.

FIG. 6 shows a second application example. As shown in FIG. 6, in this example, the display screen region 100 is arranged vertically, and two capture processing regions having areas different from each other are set respectively in the upper and lower portions of the region 100. In the first capture processing region 110 in the upper portion, plural icons are arranged. On the other hand, in the second capture processing region 120 in the lower portion, a shift key and a function key are arranged. The second application example is different from the first application example only in the setting of each region, while the capture processing of the second application example is the same as that of the first application example. In this example, it is possible to perform plural kinds of input operations by operating the icons in the first capture processing region 110 in combination with the shift key and the function key in the second capture processing region 120.

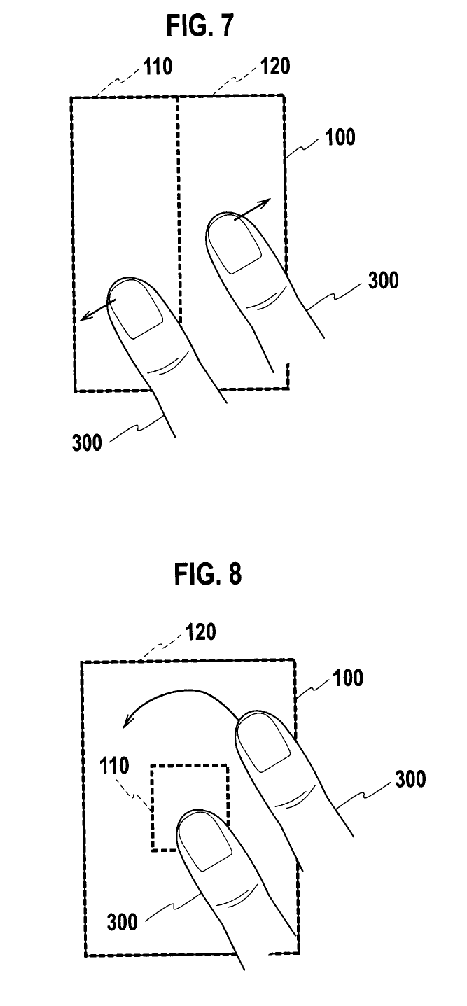

FIG. 7 shows a third application example. As shown in FIG. 7, in this example, a captured image is processed by being divided into a first capture processing region 110 and a second capture processing region 120, as in the case of the first application example shown in FIG. 5. In this case, the optical sensors 12 output electrical signals with magnitudes corresponding to the amount of received light. The image input processor 5 performs, on each region, image processing to recognize the position coordinates of a finger from an increase or a decrease in the value of the electrical signals.

This makes it possible to find an increase or a decrease in distance between the positions coordinates of one finger and the position coordinates of another finger. As a result, it is possible to perform input operations, for example, to zoom in and out of a map displayed in the screen. Specifically, when an increase in distance between the positions of two fingers approaching the display screen is detected, the map is zoomed in to be displayed. On the other hand, when a decrease in distance between the positions of the two fingers is detected, the map is zoomed out to be displayed.

FIG. 8 shows a fourth application example. As shown in FIG. 8, in this example, a captured image is processed by being divided into a first capture processing region 110 in the center of the screen and a second capture processing region 120 surrounding the periphery of the first capture processing region 110. In this example, the following input operation, for example, is possible when a finger 300 comes into contact with any coordinates in the second capture processing region 120. Specifically, a map can be moved, or the speed of the movement can be changed upon recognition of the distance from, and the angle to, the center on the basis of the coordinates of the contact position (the larger the distance between the finger and the center is, the faster the displayed image is moved). Moreover, input operations as follows are also possible when two fingers 300 come into contact respectively with the first capture processing region 110 and the second capture processing region 120 at the same time. Specifically, a displayed image may be rotated, by detecting a circular movement of one of the fingers 300 in the second capture processing region 120. Furthermore, the displayed image can be zoomed in or out, by recognizing a direction of the movement of a first finger in contact with the second capture processing region 120 relative to a second finger in contact with the center of the first capture region 110.

As described above, in the first embodiment, an image of an object approaching the display screen is captured by the optical sensors 12. The image input processor 5 divides the captured image into any plural regions. Then the image input processor 5, for each of the divided regions in parallel, detects that an object comes into contact with the display screen, and performs the image processing to obtain the coordinates of the contact position of the object. With this configuration, in this embodiment, when plural objects approach the display screen, it is possible to detect the coordinates of each of the objects in a corresponding one of the divided regions. Accordingly, simultaneous inputs using plural fingers can be achieved. As a result, an advanced input operation capable of handling more practical inputs with two or more fingers can be provided without complicated image processing.

In this embodiment, each of the optical sensors 12 detects an incident light through the display screen, and then converts the signal of the detected light into an electrical signal with a magnitude corresponding to the amount of the received light. The image input processor 5 performs, for each region, image processing to recognize an increase or a decrease in the value of electrical signals at the contact coordinates of an object. With this configuration, in this embodiment, for example, it is possible to recognize, from a change in the value of an electrical signal, that a finger has approached the display screen having plural maps or plural icons displayed thereon. Accordingly, in this embodiment, it is possible to perform input operations such as, zooming in a displayed map or a displayed icon when a decrease in the value of electrical signals is detected, and zooming out a displayed map or a displayed icon when an increase in the value of electrical signals is detected because a finger is moved away from the display screen. In the case of an icon, when a finger approaches the display screen, it is also possible to perform, in addition to the zoom-in operation, an input operation to display sub icons included in a main icon for allowing sub operations.

### Second Embodiment

Next, descriptions will be given of a display device according to a second embodiment. The basic configuration of this display device is the same as that described in the first embodiment. Hereinafter, descriptions will be given mainly of points different from those of the first embodiment.

In the configuration of the first embodiment, plural processing regions are set in advance, and image processing is then performed on each of the regions thus set. The second embodiment is different from the first embodiment in the following points. The image input processor 5 detects a movement of the contact coordinates of an object in each region. Then, the image input processor 5 mainly performs image processing to dynamically change the corresponding region in accordance with the movement of the contact coordinates.

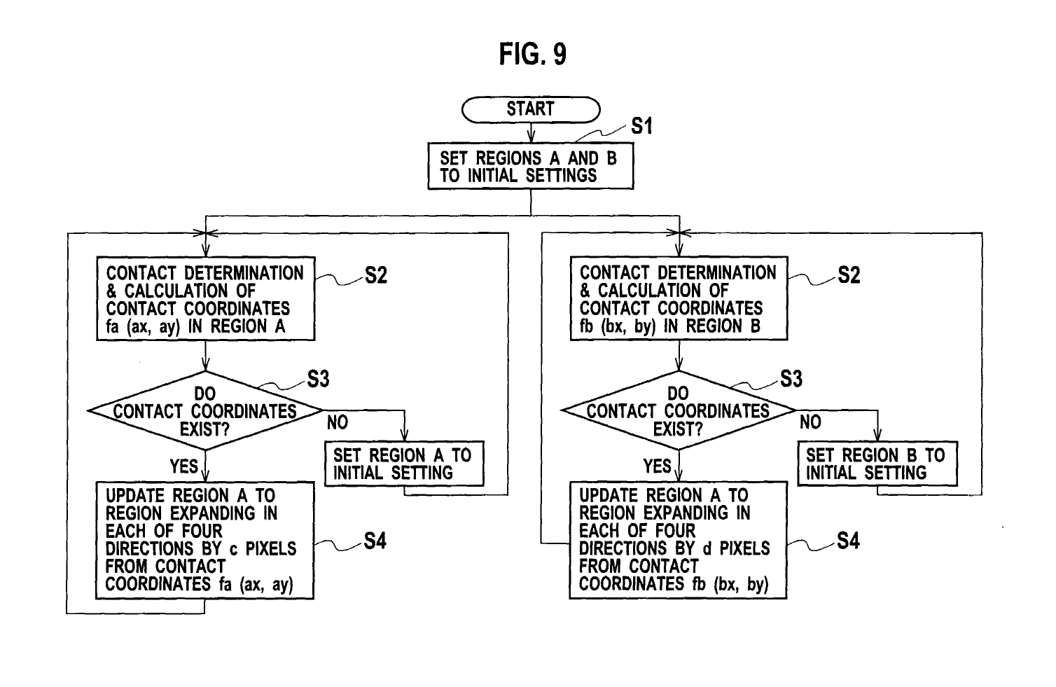

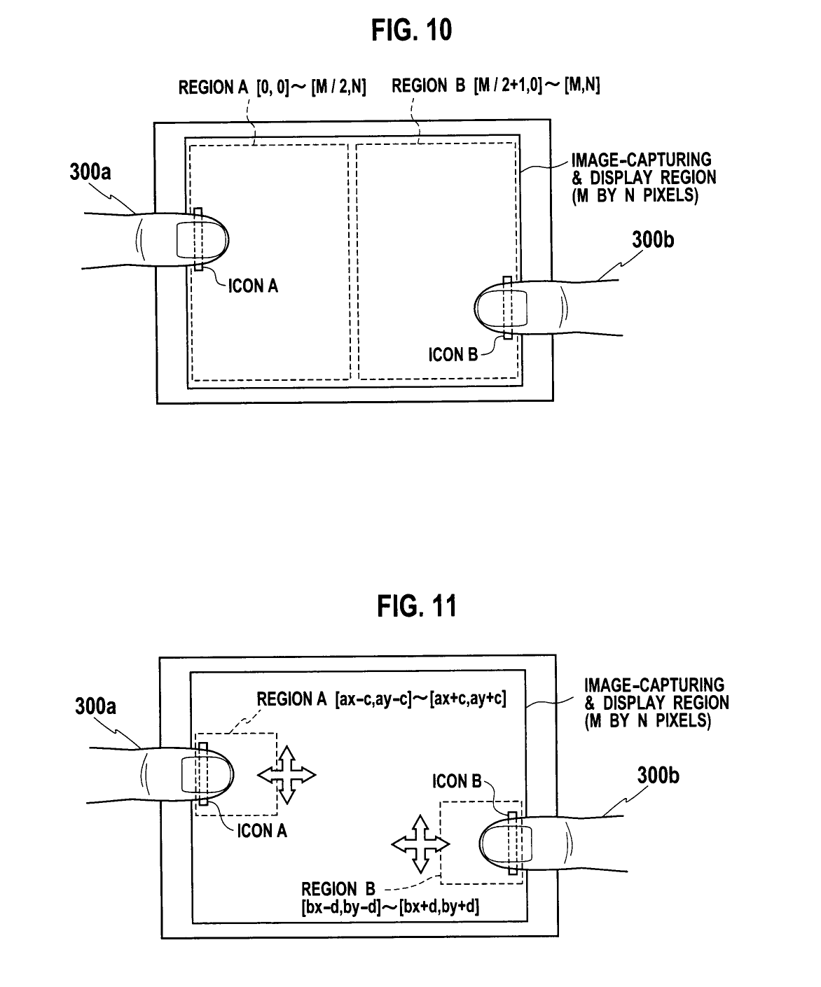

Hereinafter, the specific processing performed by the image input processor 5 will be described with a flowchart shown in FIG. 9. The image input processor 5 performs finger recognition by executing an image process computation, for example, edge processing, on a captured image based on electrical signals obtained through the conversion of optical signals. Here, descriptions will be given of finger recognition in a case where two icons A and B displayed on the screen are operated by two fingers 300a and 300b as shown in FIG. 10.

Step 1: Firstly, a captured image is divided into plural regions in advance. In this example, a captured image is divided into two capture processing regions (referred to as regions A and B below). As shown in FIG. 10, the region A including the icon A and the region B including the icon B are initially set in a display region having a size of M by N pixels (S1). Specifically, the region A is initially set to a region from (0, 0) to (M/2, N) on the left half of the display region, while the lower left corner is set as the original position. On the other hand, the region B is initially set to a region from (M/2+1, 0) to (M, N) on the right half of the display region. Here, both N and M represent positive integers.

Step 2: Subsequently, in each of the regions A and B, a contact determination is performed, and also it is determined whether or not contact coordinates exist. Then, the contact coordinates fa (ax, ay) and fb (bx, by) are calculated for the respective regions A and B (S2). In the example shown in FIG. 10, since the fingers 300a and 300b are in contact respectively with the icons A and B, the contact coordinates are calculated in each of the regions A and B. It should be noted that, in the optical input system according to the present invention, a finger being not in contact with but close to the display screen can also be recognized, unlike general resistive touch panels, capacitive touch panels, and the like. For this reason, in this description, the position coordinates of a finger detected in a state of being close to the display screen are also called the contact coordinates. In the above-described manner, it is detected that an object has come in contact with the display screen in each region.

Step 3: Next, it is determined whether or not the contact coordinates exist in each of the regions A and B. When any of the contact coordinates fa and fb exist, the processing proceeds to the next step (S3). When the contact coordinates fa and fb do not exist, the settings of the regions A and B are remained as they are, and the processing returns to Step 2.

Step 4: When the contact coordinates fa exist in the region A, the region A is updated to a region expanding in each of the four directions by c pixels from the contact coordinates fa (ax, ay) as the center (S4). As shown in FIG. 11, the region A including the icon A is updated to a square region from (ax−c, ay−c) to (ax+c, ay+c), having 2c pixels on each side. Here, c represents a predetermined positive integer. In the same manner, when the contact coordinates fb exist in the region B, the region B is updated to a region expanding in each of the four directions by b pixels from the contact coordinates fb (bx, by) as the center (S4). As shown in FIG. 11, the region B including the icon B is updated to a square region from (bx−d, by−d) to (bx+d, by +d), having 2d pixels on each side. Here, d represents a predetermined positive integer. As described above, each of the region A and the region B is updated to a region including the contact coordinates fa or fb of the corresponding object, and also being smaller than the region of the initial setting.

Thereafter, the processing returns to Step 2. It is then determined whether or not the contact coordinates exist in each of the newly-set regions A and B, so that the regions A and B are dynamically updated in the same procedure. When the contact coordinates no longer exist, the processing is restarted by resetting the regions with the newly-updated range to the initial settings.

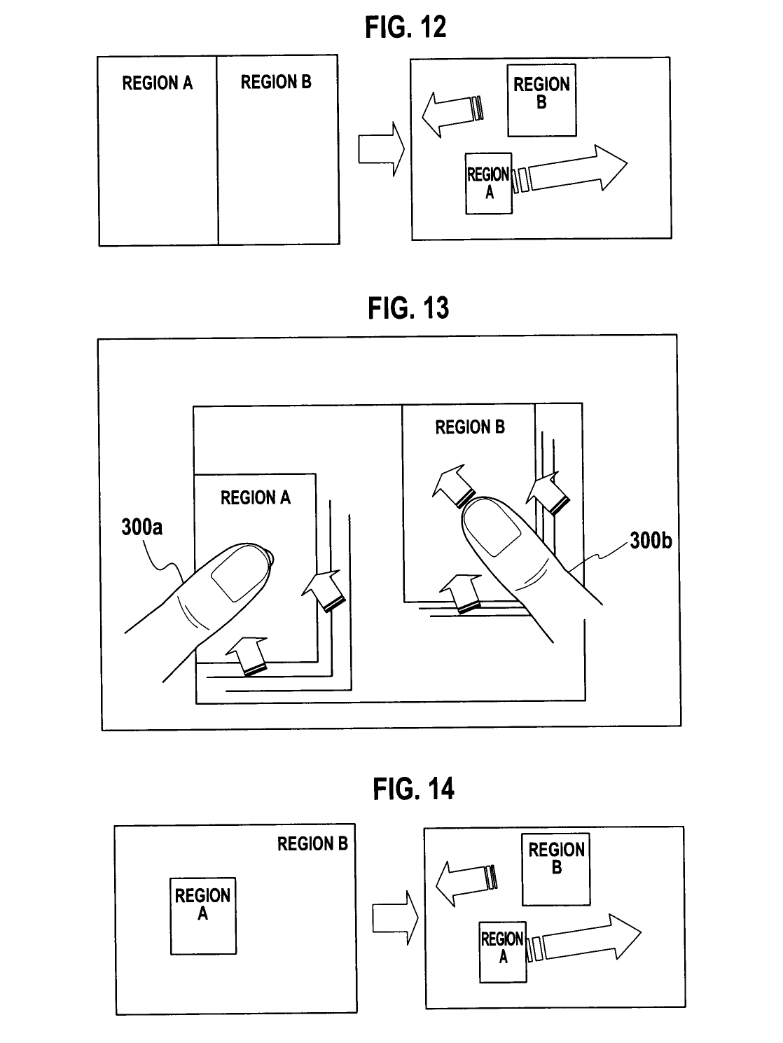

In this manner, as shown in FIG. 12, the contact of a finger is firstly detected in each of the regions A and B both of which are initially fixed. Once the contact of the finger is detected, a corresponding one of the regions A and B is changed to a smaller area having the contact coordinates as its center so that the recognition can be continued in the smaller area. Moreover, upon detection of a movement of the contact coordinates in each of the regions A and B, the corresponding region is dynamically updated on the basis of the contact coordinates. Accordingly, it is possible to move the regions A and B in association with the movements of the corresponding objects. As a result, as shown in FIG. 13, it is possible to drag an icon displayed in each of the regions A and B on the screen by a corresponding one of the two fingers 300a and 300b.

In the above-described flowchart, once the contact coordinates no longer exist, the regions are immediately reset to the initial settings. However, the present invention is not limited to this example. By previously setting a time to the resetting of a region to the initial setting, the present invention may be applied to an input operation in which an object is once removed from the display screen, as in the case of tapping (a pen input) or clicking (a finger input).

As described above, in the second embodiment, the image input processor 5 detects a movement of the contact coordinates of an object in each region, and then performs image processing to dynamically change the region in accordance with the movement of the contact coordinates. Accordingly, in this embodiment, it is possible to cause the region to follow the movement of the object. In addition, in this embodiment, it is possible to calculate and move the position coordinates outside a region that has been initially set. Accordingly, in addition to the effects of the first embodiment, it is possible to perform operations of dragging and scrolling plural icons displayed on the screen. In the first embodiment, since a processing region is set in advance, finger recognition can be performed only in that set region. For this reason, the first embodiment has limitations in the input operations. For example, when the finger goes off that set region during a dynamic operation such as dragging, the finger recognition is failed, so that a malfunction occurs. According to the second embodiment, it is possible to avoid such a problem, and to thus achieve an advanced input operation for finger inputs in any plural regions without complicating image processing.

Moreover, in the second embodiment, it is desirable to perform the following image processing. Specifically, a captured image is previously divided into plural regions. When it is detected that an object comes into contact with the display screen in each of the divided regions, the divided region where the contact of the object is detected is changed to a region including the position coordinates of the object, and also being smaller than the divided region.

Note that, although the region A and the region B are set previously by dividing the screen into two parts in the second embodiment, the setting of regions is not limited to this case. The regions A and B may alternatively be set by dividing, when an object comes into contact with the screen, a captured image into a center region including the position coordinates of the object, and a peripheral region located around the first region. For example, as shown in FIG. 14, when one finger comes into contact with the screen, the region A is set to a region expanding in each of the four directions by c pixels from the contact coordinates fa (ax, ay) as the center as in the above-described manner, while the region B is set to a region outside the region A. Then, when a next finger comes into contact with the screen in the region B, the region B is newly set to a region expanding in each of the four directions by d pixels from the contact coordinates fb (bx, by) as the center as in the above-described manner. Thereafter, the regions A and B may be updated in accordance with the movements of the corresponding fingers. This configuration makes it possible to reduce limitations associated with the initial positions of the operation on the screen. As a result, more comfortable operation can be achieved.

Although the calculations of the position coordinates in the regions A and B are processed in parallel in the second embodiment, the calculation may alternatively be sequentially processed.

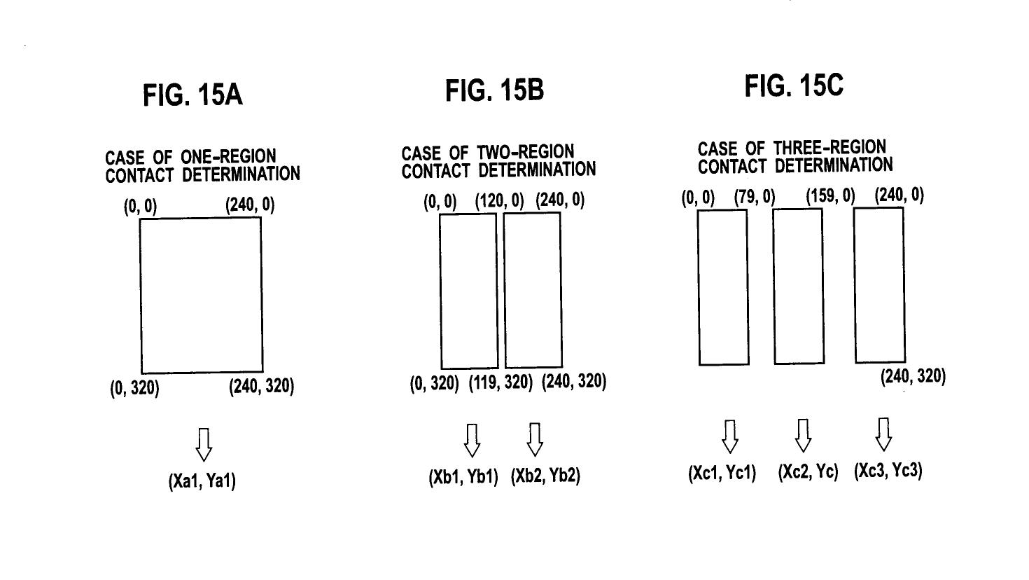

Note that, although the number of processing regions into which a captured image is divided is 2 in each of the above-described embodiments, the number is not limited to this. A captured image may be further divided into more than two regions so that inputs using plural fingers can be achieved. Moreover, it is desirable to provide plural modes, as described below, which can be switched from one to the other. One is a basic mode in which the entire display screen is handled as a single processing region. The other is a mode in which the display screen is divided into plural regions. Hereinafter, this configuration will be described with reference to FIGS. 15A to 15C.

FIGS. 15A to 15C show an example in which a captured image is divided into plural processing regions in a QVGA panel having 240 by 320 pixels arranged in a matrix. FIG. 15A shows a basic mode in which the entire display screen is handled as a single processing region. FIG. 15B shows a two-division mode in which the display screen is divided into two processing regions. FIG. 15C shows a three-division mode in which the display screen is divided into three processing regions. The mode switching may be configured as follows. When the mode is to be switched, a selection menu is displayed on the screen. Through the selection menu, the user can select one of the modes by means of an optical input system. Then, the mode is switched to that designated by the user. A captured image is processed in each region of the selected mode, so that the contact coordinates and the contact information are outputted. In this case, the memory necessary for the output of the contact coordinates and the contact information may be used for each of the divided regions. Accordingly, there is no need for adding a new memory.

What is claimed is:

1. A display device comprising:
a display unit which displays an image on a display screen;
an optical input unit which captures an image of an object approaching the display screen; and
an image processor which detects that the object comes into contact with the display screen on the basis of a captured image captured by the optical input unit, and which then performs image processing to obtain the position coordinates of the object, wherein
the image processor divides the captured image into a plurality of regions, and performs the image processing on each of the divided regions.

2. The display device according to claim 1 wherein
the optical input unit is an optical sensor which detects an incident light through the display screen, and which then converts a signal of the detected light into an electrical signal with a magnitude corresponding to the amount of the received light, and
the image processor further performs any one of first image processing to recognize an increase or a decrease in the value of the electrical signal at the position coordinates of the object in each of the divided regions;
and second image processing to recognize the distance between the position coordinates of one of a plurality of objects and the position coordinates of another one of the plurality of objects.

3. The display device according to claim 1 wherein
the image processor divides the captured image into a plurality of regions in advance, and
upon detection of the contact of the object with each of the divided regions in the display screen, the image processor further performs image processing to change a first region where the contact of the object is detected to a second region including the position coordinates of the object, and also being smaller than the first region.

4. The display device according to claim 1 wherein
upon detection of the contact of the object with the display screen, the image processor further performs image processing to divide the captured image into a center region including the position coordinates of the object and a peripheral region located around the first region.

5. The display device according to any one of claims 3 and 4 wherein
the image processor detects a movement of the position coordinates of the object in each of the divided regions, and further performs image processing to dynamically change, in accordance with the movement of the position coordinates, a region where the movement of the position coordinates of the object is detected.
